(19) United States
(12) Patent Application Publication
(10) Pub. No.: US 2026/0147660 A1
(43) Pub. Date: May 28, 2026

(54) RULE ENGINE FOR ROOT CAUSE ANALYSIS

(71) Applicant: Nokia Solutions and Networks Oy, Espoo (FI)

(72) Inventors: Bilgehan ERMAN, Murray Hill, NJ (US); Federica GIAMPETRAGLIA, Massy (FR); Catello DI MARTINO, Sao Paulo (BR); Bruce CILLI, Murray Hill, NJ (US)

(21) Appl. No.: 19/391,259

(22) Filed: Nov. 17, 2025

(30) Foreign Application Priority Data
Nov. 26, 2024 (FI) 20246388

(51) Int. Cl. G06F 11/07

(52) U.S. Cl. CPC G06F 11/079; G06F 11/0709

(57) ABSTRACT

A method for determining at least one root cause of at least one detected anomaly in a network includes determining an influence score for each respective candidate anomaly of a plurality of candidate anomalies based on a correlation with other ones of the plurality of candidate anomalies, ranking the plurality of candidate anomalies based on the respective influence scores, updating, based on the ranked plurality of candidate anomalies, a rule engine by simplifying at least one of a Bayesian network or a conditional probability table, determining at least one root cause of the at least one detected anomaly based on the rule engine and the at least one detected anomaly, and displaying the at least one root cause.

### BACKGROUND

Expert-prepared documents for network fault management provide comprehensive guidance on event analysis, root cause identification, and follow-up actions to enhance diagnosis. However, these documents are primarily designed for human interpretation, making them less suitable for automated diagnostic and maintenance systems.

### SUMMARY

The scope of protection sought for various example embodiments of the disclosure is set out by the independent claims. The example embodiments and/or features, if any, described in this specification that do not fall under the scope of the independent claims are to be interpreted as examples useful for understanding various embodiments.

One or more example embodiments provide methods, apparatuses and/or non-transitory computer readable mediums for processing expert prepared documents for network fault management as automated procedures via a rule engine, which can indicate probabilistic root causes based on detected anomalies.

One or more example embodiments disclose an anomaly ranking algorithm for generating a quantified list of anomalies. The anomalies may be ranked by their associative strengths for prioritizing attention.

One or more example embodiments provide methods, apparatuses and/or non-transitory computer readable mediums for representing expert guidelines as structured knowledge graphs, enabling the construction of automated procedures through a rule engine for suggesting probabilistic root causes based on detected anomalies.

One or more example embodiments disclose an anomaly ranking algorithm for generating a prioritized list of anomalies, ranked by their associative strengths, to focus attention on the most critical issues.

At least one example embodiment provides a method for determining at least one root cause of at least one detected anomaly in a network, the method including determining an influence score for each respective candidate anomaly of a plurality of candidate anomalies based on a correlation with other ones of the plurality of candidate anomalies, ranking the plurality of candidate anomalies based on the respective influence scores, updating, based on the ranked plurality of candidate anomalies, a rule engine by simplifying at least one of a Bayesian network or a conditional probability table, determining at least one root cause of the at least one detected anomaly based on the rule engine and the at least one detected anomaly, and displaying the at least one root cause.

The simplifying at least one of the Bayesian network or the conditional probability table may include regenerating at least one of the Bayesian network or the conditional probability table based on the ranked plurality of candidate anomalies and a diagnostic knowledge graph, the diagnostic knowledge graph specifying a probabilistically quantified relation between the at least one root cause and the candidate anomalies.

The method may further include generating at least one of the Bayesian network or the conditional probability table based on the diagnostic knowledge graph, the diagnostic knowledge graph including at least one anomaly node, at least one constraint node, at least one action node, and at least one root cause node, wherein edges of the diagnostic knowledge graph indicate anomaly to root cause relations and correlations between anomalies.

The anomaly to root cause relations may be probabilistically quantified.

The edges may further indicate anomaly to action relations.

The simplifying may include reducing a complexity of the conditional probability table by including only a subset of the candidate anomalies having a highest influence score in the regenerating the conditional probability table.

The method may further include displaying at least one recommended action based on the at least one root cause.

The determining the influence score for each respective candidate anomaly may include determining the influence score for each respective candidate anomaly of the plurality of candidate anomalies based on the at least one recommended action.

The determining the influence score for each respective candidate anomaly may include determining the influence score for each respective candidate anomaly of the plurality of candidate anomalies based on environmental conditions of the network.

The influence score may indicate a significance of the respective candidate anomaly in terms of a degree of correlation of the respective candidate anomaly with the other ones of the plurality of candidate anomalies.

The method may further include automatically performing at least one action to improve the determining the at least one root cause, the at least one action based on the at least one root cause.

At least one example embodiment provides a device including at least one memory storing computer program code and at least one processor configured to execute the computer program code and cause the device to determine an anomaly influence score for each respective candidate anomaly of a plurality of candidate anomalies based on a correlation with other ones of the plurality of candidate anomalies, rank the plurality of candidate anomalies based on the respective influence scores, update, based on the ranked plurality of candidate anomalies, a rule engine by simplifying at least one of a Bayesian network or a conditional probability table, determine at least one root cause of the at least one detected anomaly based on the rule engine and the at least one detected anomaly, and display the at least one root cause.

The at least one memory and the computer program code may be further configured to, with the at least one processor, cause the device to simplify at least one of the Bayesian network or the conditional probability table by regenerating at least one of the Bayesian network or the conditional probability table based on the ranked plurality of candidate anomalies and a diagnostic knowledge graph, the diagnostic knowledge graph specifying a probabilistically quantified relation between the at least one root cause and the candidate anomalies.

The at least one memory and the computer program code may be further configured to, with the at least one processor, cause the device to generate at least one of the Bayesian network or the conditional probability table based on the diagnostic knowledge graph, the diagnostic knowledge graph including at least one anomaly node, at least one constraint node, at least one action node, and at least one root cause node, wherein edges of the diagnostic knowledge graph indicate anomaly to root cause relations and correlations between anomalies.

The anomaly to root cause relations may be probabilistically quantified.

The edges may further indicate anomaly to action relations.

The at least one memory and the computer program code may be further configured to, with the at least one processor, cause the device to reduce a complexity of the conditional probability table by including only a subset of the candidate anomalies having a highest influence score in the regenerating the conditional probability table.

The at least one memory and the computer program code may be further configured to, with the at least one processor, cause the device to display at least one recommended action based on the at least one root cause.

The at least one memory and the computer program code may be further configured to, with the at least one processor, cause the device to determine the influence score for each respective candidate anomaly based on the at least one recommended action.

The at least one memory and the computer program code may be further configured to, with the at least one processor, cause the device to determine the influence score for each respective candidate anomaly of the plurality of candidate anomalies based on environmental conditions.

The influence score may indicate a significance of the respective candidate anomaly in terms of a degree of correlation of the respective candidate anomaly with the other ones of the plurality of candidate anomalies.

The at least one memory and the computer program code may be further configured to, with the at least one processor, cause the device to automatically perform at least one action to improve the determining the at least one root cause, the at least one action based on the at least one root cause.

At least one example embodiment provides a non-transitory computer-readable storage medium storing computer-readable instructions that, when executed, cause one or more processors to cause a device to perform a method for determining at least one root cause of at least one detected anomaly in a network, the method including determining an influence score for each respective candidate anomaly of a plurality of candidate anomalies based on a correlation with other ones of the plurality of candidate anomalies, ranking the plurality of candidate anomalies based on the respective influence scores, updating, based on the ranked plurality of candidate anomalies, a rule engine by simplifying at least one of a Bayesian network or a conditional probability table, determining at least one root cause of the at least one detected anomaly based on the rule engine and the at least one detected anomaly, and displaying the at least one root cause.

At least one example embodiment provides a device including a means for determining an influence score for each respective candidate anomaly of a plurality of candidate anomalies based on a correlation with other ones of the plurality of candidate anomalies, a means for ranking the plurality of candidate anomalies based on the respective influence scores, a means for updating, based on the ranked plurality of candidate anomalies, a rule engine by simplifying at least one of a Bayesian network or a conditional probability table, a means for determining at least one root cause of the at least one detected anomaly based on the rule engine and the at least one detected anomaly, and a means for displaying the at least one root cause.

### BRIEF DESCRIPTION OF THE DRAWINGS

Example embodiments will become more fully understood from the detailed description given herein below and the accompanying drawings, wherein like elements are represented by like reference numerals, which are given by way of illustration only and thus are not limiting of this disclosure.

FIG. 1 is a block diagram illustrating an example system according to example embodiments.

FIG. 2 illustrates an example entity relationship (ER) diagram of a diagnostic knowledge model, according to example embodiments.

FIG. 3 is an example instantiation of a diagnostic knowledge graph according to example embodiments.

FIG. 4 is an example of a Bayesian network instance according to example embodiments.

FIG. 5 is a flow chart illustrating an anomaly attention ranking method according to example embodiments.

FIG. 6 illustrates example pseudocode for the anomaly attention ranking algorithm according to example embodiments.

FIG. 7 is a flow chart illustrating a method for generating a rule engine, according to example embodiments.

FIG. 8 is a flow chart illustrating a method of a rule engine, according to example embodiments.

FIG. 9 is an illustration of example input and output vectors for a rule engine according to example embodiments.

It should be noted that these figures are intended to illustrate the general characteristics of methods, structure and/or materials utilized in certain example embodiments and to supplement the written description provided below. These drawings are not, however, to scale and may not precisely reflect the precise structural or performance characteristics of any given embodiment, and should not be interpreted as defining or limiting the range of values or properties encompassed by example embodiments. The use of similar or identical reference numbers in the various drawings is intended to indicate the presence of a similar or identical element or feature.

### DETAILED DESCRIPTION

Various example embodiments will now be described more fully with reference to the accompanying drawings in which some example embodiments are shown.

Detailed illustrative embodiments are disclosed herein. However, specific structural and functional details disclosed herein are merely representative for purposes of describing example embodiments. The example embodiments may, however, be embodied in many alternate forms and should not be construed as limited to only the embodiments set forth herein.

It should be understood that there is no intent to limit example embodiments to the particular forms disclosed. On the contrary, example embodiments are to cover all modifications, equivalents, and alternatives falling within the scope of this disclosure. Like numbers refer to like elements throughout the description of the figures.

While one or more example embodiments may be described from the perspective of rule engine (RE) device or the like, it should be understood that one or more example embodiments discussed herein may be performed by the one or more processors (or processing circuitry) at the applicable device. For example, according to one or more example embodiments, at least one memory may include or store computer program code, and the at least one memory and the computer program code may be configured to, with at least one processor, cause a device to perform the operations discussed herein.

Example embodiments introduce a novel method, apparatus and non-transitory computer-readable storage medium for automatically identifying root causes of network anomalies. To leverage expert knowledge more effectively, example embodiments include a semantic model for constructing a knowledge graph that captures essential relationships between network diagnostic entities with reduced or minimal structural complexity while maintaining semantic completeness.

Example embodiments disclose a method for instantiating Bayesian networks (BNs) to serve as a rule engine (RE). By also incorporating an anomaly association algorithm, this design allows experts to filter and select the most critical entities when defining conditional probability tables (CPTs) of the Bayesian networks. Without this filtering, the CPTs may grow exponentially with the number of entities, rendering the solution impractical.

Filtering and/or selecting the most critical entities may involve a large number of interrelated entities (e.g., anomalies) having a large number of interrelations among and between the anomalies. The methodology and example embodiments described herein therefore could not be practically performed in the human mind.

Example embodiments disclose a unique input vector that integrates three different types of information into a uniform vector. These include key performance indicator (KPI) anomaly state indicators, contextual state indicators related to the environment, and/or indicators reflecting the results of actions triggered by the rule engine's output. The rule engine produces a distinctive multi-vector output: one vector provides a ranked list of probable root causes, while another suggests actions (such as conducting specific tests) that can enhance the root cause analysis. For each action, the rule engine's input also includes a representation to incorporate the action's outcomes into the next computational cycle.

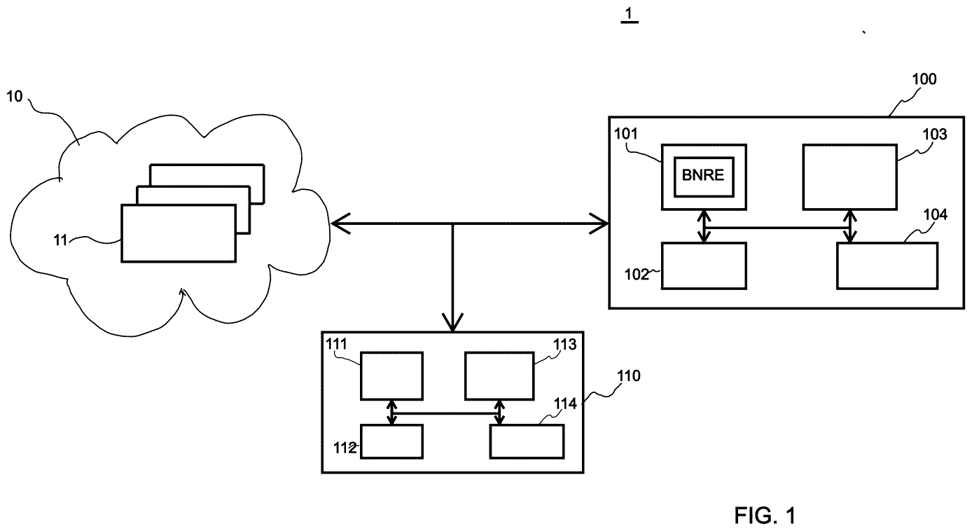

FIG. 1 is a block diagram illustrating an example system according to example embodiments.

Referring to FIG. 1, a system 1 includes a network 10, a rule engine (RE) device 100, and/or an anomaly detection device 110.

The RE device 100 may include processing circuitry (such as at least one controller 101), a memory 102, a communication interface 103, and/or one or more input/output devices 104 (e.g., a user input device (such as a keyboard, a keypad, a mouse, and the like), a user output device (such as a display, a speaker, or the like). The RE device 100 may be, but is not limited to, a mobile device, a smartphone, a tablet, a laptop computer, a desktop computer or the like. The RE device 100 may be configured to perform the RE functions described in accordance with one or more example embodiments. For example, the controller 101 may implement a Bayesian network rule engine (BNRE). The BNRE may include at least one BN instance, at least one CPT, an anomaly attention ranking algorithm (AARA), at least one attention ranked anomalies (ARA) report, a diagnostic knowledge model (DKM), and/or a diagnostic knowledge graph (DKG). The BNRE will be described in more detail later.

The memory 101 may include various special purpose program code including computer executable instructions which may cause the RE device 100 to perform the one or more of the methods of the example embodiments. The communication interface 103 may include a wireless communication interface and/or a wired communication interface.

In at least one example embodiment, the processing circuitry may include at least one processor (and/or processor cores, distributed processors, networked processors, etc.), such as the at least one controller 101, which may be configured to control one or more elements of the RE device 100, and thereby cause the RE device 100 to perform various operations. The processing circuitry (e.g., the at least one controller 101, etc.) is configured to execute processes by retrieving program code (e.g., computer readable instructions) and data from the memory 102 to process the program code and data, thereby executing special purpose control and functions of the entire apparatus 100. Once the special purpose program instructions are loaded into the at least one controller 101, for example, the at least one controller 101 executes the special purpose program instructions, thereby transforming the at least one controller 101 into a special purpose controller or processor.

In at least one example embodiment, the memory 102 may be a non-transitory computer-readable storage medium and may include a random access memory (RAM), a read only memory (ROM), and/or a permanent mass storage device such as a disk drive, or a solid state drive. Stored in the memory 102 is program code or computer readable instructions related to operating the RE device 100.

The network 10 may include a plurality of devices 11. The plurality of devices 11 may include, for example, drones, autonomous vehicles, mobile devices, smartphones, tablets, laptop computers, desktop computers or the like. The plurality of devices 11 may be networked together via any known networking technology. For example, the plurality of devices 11 of the network 10 may be connected via a Wi-Fi® network. For example, the network 10 may be a field operations system. For example, the network 10 may be an autonomous mining network and at least some devices of the plurality of devices may be autonomous mining vehicles. However, example embodiments are not limited to these examples.

The anomaly detection device 110 may include processing circuitry (such as at least one controller 111), a memory 112, a communication interface 113, and/or one or more input/output devices 114 (e.g., a user input device (such as a keyboard, a keypad, a mouse, and the like), a user output device (such as a display, a speaker, or the like). Descriptions of the at least one controller 111, the memory 112, the communication interface 113, and the one or more input/output devices may be similar to the corresponding components described above with reference to the RE device 100. Thus, a detailed discussion is omitted.

The RE device 100 is shown, in FIG. 1, separate from the network 10. In this configuration, the RE device 100 may be configured to communicate with the network 10, via the communication interface 103, by any known method. For example, via the Internet™. However, example embodiments are not limited to this example. For example, the RE device 100 may be included in the network 10.

The anomaly detection device 110 is shown, in FIG. 1, separate from the network 10 and the RE device 100. However, example embodiments are not limited to this example. For example, the anomaly detection device 110 may be a device of the plurality of devices 11 on the network 10 and/or the anomaly detection device 110 may be implemented by the RE device 100.

The anomaly detection device 110 may be configured to receive key performance indicators (KPIs) from the plurality of devices, detect anomalies in the KPIs, and report the anomalies to the BNRE of the RE device 100. For example, devices 11 may generate KPI values and transmit the KPI values to the anomaly detection device 110. The anomaly detection device 110 may process the KPI values by comparing the values to thresholds (e.g., service level agreement thresholds) to detect anomalies. For example, the anomaly detection device 110 may determine an average of reference signal received power (RSRP) KPI values of a device 11 collected in the last minute to be greater than-80 dBm. If an average is found to be less than this threshold value, then an “RSRP too low” anomaly may be detected. However, example embodiments are not limited to these examples and the anomaly detection device 110 may detect anomalies of the devices 11 according to any known method.

The anomaly detection device 110 reports the detected anomalies to the BNRE. For example, the anomaly detection device 110 may report the detected anomalies via an input vector 901 including a list of known anomalies and an indication of true or false for each known anomaly. The input vector 901 will be described in more detail later. However, example embodiments are not limited to this example, and the anomaly detection device 110 may report detected anomalies to the BNRE according to any known method.

According to some example embodiments, the network 10 may be a digital twin (DT). A DT is a virtual replica of an existing or planned real-world physical system, using computer models. DTs can be used to simulate the real-world system to perform analysis of different system configurations or system changes.

A diagnostic knowledge model (DKM), according to example embodiments, is an abstract model that provides a structural representation of network diagnostic knowledge (e.g., captures the semantic structure of network diagnostic guidelines) as are prescribed by experts. A DKM may include lists of expected anomaly types, their correlations, root causes, and/or information on additional actions to be taken (tests to be executed) to improve root cause likelihood predictions and augment the results.

According to example embodiments, the methodologies outlined in a DKM may be represented as a knowledge graph.

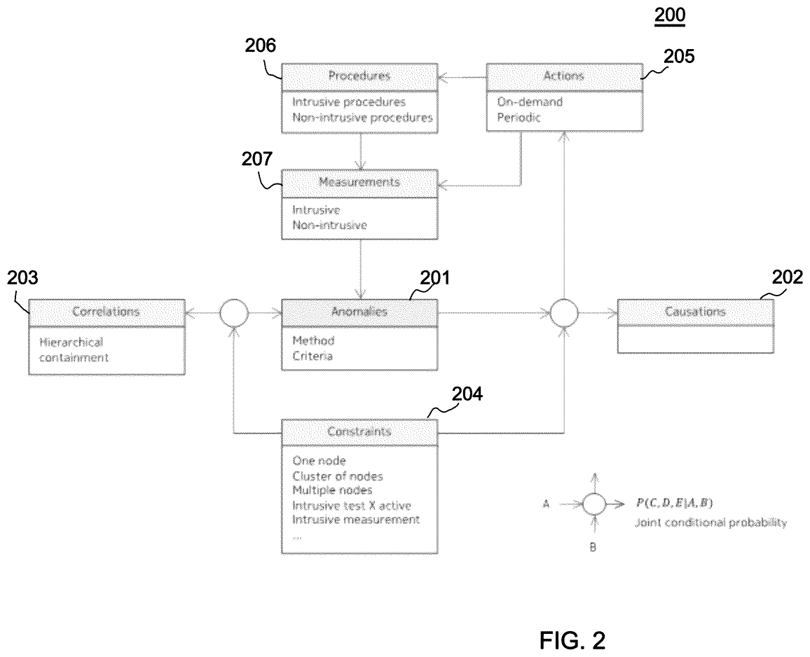

FIG. 2 illustrates an example entity relationship (ER) diagram of a diagnostic knowledge model (DKM), according to example embodiments.

Referring to FIG. 2, a DKM 200 may include anomalies 201, causations 202, correlations 203, constraints 204, actions 205, procedures 206, and/or measurements 207.

The anomalies 201 describe conditions and/or events that deviate from a normal operation within the system. The anomalies 201 may indicate potential issues within the system. Detecting anomalies may involve using specific methods and criteria that define what constitutes an abnormal condition. Anomalies in the system 1 may be detected according to any known method and/or criteria. For example, the anomaly detection device 110 may detect the anomalies 201.

The causations 202 involve determining cause-effect relationships between various factors or events. By understanding causations, the system 1 can identify underlying reasons for anomalies and/or take appropriate actions to address them.

The correlations 203 may indicate associations among and/or between the anomalies 201 and dynamic relationships among and/or between the anomalies 201. When network problems occur, multiple anomalies 201 often appear simultaneously. The system 1 may rank and filter the correlations 203 based on their centrality. This prioritization aids in selecting key anomalies for populating Bayesian network-based rule engine (BNRE) instances, described in more detail later.

The constraints 204 represent conditions that affect how anomalies 201 are interpreted. The constraints 204 include factors such as the involvement of one node, a cluster of nodes, and/or multiple nodes across the network 100, and/or specific conditions such as an intrusive test being active and/or an intrusive measurement.

The actions 205 represent activities undertaken to take measurements, execute tests and/or execute procedures within the system 1. Triggers for the actions 205 may vary. For example, the triggers may occur periodically as part of a regular schedule and/or be initiated on-demand, often in response to detected anomalies 201.

The procedures 206 are tasks used to gather data and/or perform actions. The procedures 206 may be categorized into two types: intrusive and non-intrusive procedures. Intrusive procedures involve a more direct interaction with the system 1, potentially affecting its operation, while non-intrusive procedures gather data or perform actions without significantly altering a state of the system 1.

The measurements 207 are data collection activities that provide inputs used for analysis. Similar to the procedures 206, the measurements 207 can also be intrusive or non-intrusive. Intrusive measurements may impact a normal operation of the system 1, while non-intrusive measurements aim to collect data without causing disruption of the system 1.

According to example embodiments, a concept of joint conditional probability P (C,D|A,B) is used to represent a probability of events C and D, occurring given that events A, and B has occurred. This probabilistic reasoning may be used to assess the likelihood of root causes (e.g., causations 202) given a set of anomalies 201 under certain conditions. Bayesian network (BN) models may compute individual components of the joint probability using Equations 1-3.

$$P ( C ) = {\sum }_{A , B , D} P ( C , D , A , B ) \qquad Equation 1$$

$$P ( C , D , A , B ) = P ( C \vert D , A , B ) * P ( D \vert A , B ) * P ( A , B ) \qquad Equation 2$$

$$P ( C ) = {\sum }_{A , B , D} P ( C \vert D , A , B ) * P ( D \vert A , B ) * P ( A , B ) \qquad Equation 3$$

The DKM 200 may be converted to a graph structure for use by a BN and/or an anomaly attention ranking engine (AARE), described in more detail below. For example, according to example embodiments, a diagnostic knowledge graph (DKG) may be generated based on the DKM knowledge graph 200. For example, an expert and/or programmer may convert the DKM knowledge graph 200 to a DKG. However, example embodiments are not limited to this example. For example, any known automatic algorithm may be used to generate the DKG.

The DKG is a graph structure that allows representation of four types of nodes: anomalies; constraints; actions; and root causes. The root causes and the actions may be query nodes (QN). The QN provide a quantified list of result values.

Edges of the DKG graph indicate anomaly to root cause relations and correlations between anomalies.

For general forms of BNs, graph structures must be a directed acyclic graph. However, DKGs according to example embodiments may not be strictly required to be directed acyclic graphs. A DKG according to example embodiments may only be acyclic on paths involving action nodes and root cause nodes. The remaining part of the graph that defines the anomaly associations can be cyclic. This relaxation allows the same graph to be used for multiple purposes.

For example, the DKG according to example embodiments may be used for both of creation of instances of BNs and for ranking of anomalies based on their associations with each other by the AARE, which is described in more detail later. However, example embodiments are not limited to these examples. For example, a directed acyclic graph may be used for multi-layer Anomaly/Root cause representations, and a separate graph may be used to represent associations between anomalies.

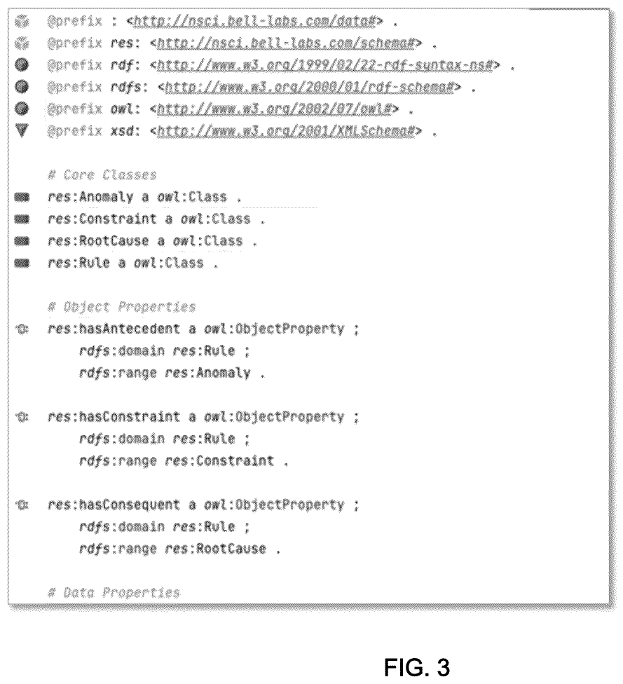

Many alternative formats may be used to create the DKG, according to example embodiments. A format of the DKG is not particularly limited. An example of an instantiation of a DKG using an RDF Turtle™ format is shown in FIG. 3 using symbolic data.

A rule engine (RE) for determining at least one root cause anomaly according to example embodiments may be implemented using a Bayesian network (BN) technique. The BN may be generated based on a directed graph representation of the DKG (e.g., a directed subgraph of the DKG) and/or conditional probability tables (CPTs) that specify parameterization of conditional probability distributions (CPD) within the BN. A BN instance may be a representation of QNs for each (or one or more) DKG node type of action and root cause, as described above with reference to FIG. 2. A BN instance may include the representation of QNs which encode probability values of the CPT. According to some example embodiments, the BN may be implemented in the form of a microservice.

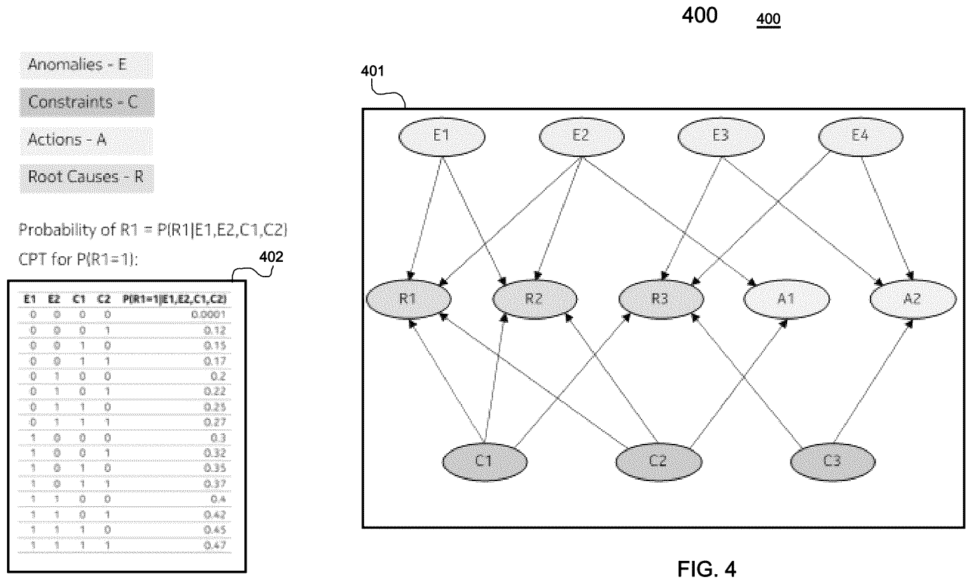

FIG. 4 is an example of a BN instance according to example embodiments.

As discussed above, and as shown in FIG. 4, a BN instance 400 may include a representation of QNs 401 and encoding of probability values of the CPT 402. Probability values shown in the example CPT 402 are for example purposes only and the example embodiments are not limited to the example values shown. Example embodiments may use an Excel® application to create a comma separated values (CSV) file format as a CPT 402. However, example embodiments are not limited thereto and a CPT 402, according to example embodiments, may be any known format.

The example shown in FIG. 4 is presented for example purposes to describe the parent/child relations of the entities of the BN 400. In real world scenarios, however, a BN 400 may include a QN 401 having hundreds or thousands of nodes.

As shown in FIG. 4, the QN 401 may include anomaly nodes E, constraint nodes C, action nodes A, and/or root cause nodes R.

The CPT 402 may include probabilities of a root cause node R for each combination of anomaly nodes E and constraint nodes C. For example, the CPT 402 shows a portion of a CPT table including probabilities of root cause R1 based on various combinations of anomalies E1 and E2 and constraints C1 and C2.

Generation of a CPT 402 is based on parent child relationships between anomaly nodes E and root cause nodes R, and on probability values associated with the edges between anomaly nodes E and root cause nodes R. The (e.g., primary) role of the BN is to quantify the probability of a particular root cause node R (child node) given a set of anomaly nodes E (parent nodes). During the CPT creation process, these relationships are derived from a knowledge graph (e.g., a DKG). The probability values for each edge (relationship arrow) between the parent anomaly node E and the child root cause node R are also encoded in the DKG.

A challenge associated with such large BNs is populating the CPT 402. For example, a script (e.g., a Python™ script, etc.) may utilize this information to create a CPT 402 for each root cause node R. However, a key challenge arises when too many anomaly nodes E are linked to a single root cause node R. Constructing CPTs with all possible combinations of these anomaly nodes E (e.g., selecting 1, 2, 3, . . . out of N) would become impractical.

An anomaly attention ranking algorithm (ARA), discussed in more detail later, may address this challenge by allowing the system to select only the most relevant, few number of anomalies when populating the BN's CPTs during an automatic instantiation process. For example, 3 to 4 top ranked anomalies may be used to generate the CPTs 402. However, example embodiments are not limited to this example, and more or fewer anomalies may be used to generate the CPTs 402. For example, the controller 101 may generate a CPT for each, or one or more, root cause node R, with each CPT being based on only the most relevant few number of anomalies.

According to some example embodiments, the BN 400 (e.g., an instance of a BN 400) may be created using a Python™ library. For example, the Python™ library pypgm. However, example embodiments are not limited to this example, and the BN 400 may be created according to any known methods.

The BN 400, according to example embodiments, provides a quantified determination of root causes and/or recommended actions based on expert knowledge. A user may query the BN 400 to identify specific anomalies. For example, the user may input a particular anomaly E. The BN 400 may identify correlated anomalies E, potential causes R, active tests A, and/or relevant constraints C in response to an input anomaly E.

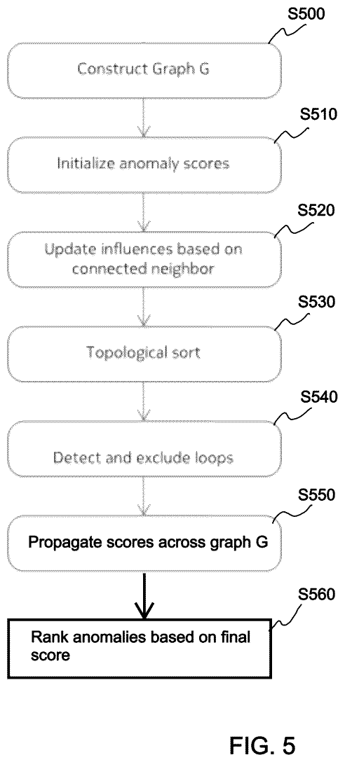

FIG. 5 is a flow chart illustrating an anomaly attention ranking method, according to example embodiments. The method shown in FIG. 5 may be performed at the controller 101.

The anomaly attention ranking method shown in in FIG. 5 may be referred to herein as an anomaly attention ranking algorithm (AARA).

Referring to FIG. 5, at S500 the controller 101 generates a directed subgraph G from the DKG. The nodes of the directed subgraph G may correspond with the anomalies 201 and/or the edges of the directed subgraph G may correspond with the correlations 203. For example, data for generating the directed subgraph G (e.g., the anomalies 201 and/or correlations 203) may be retrieved from the DKG by choosing only the parent/child relation which may be labeled as root-cause relations.

At S510, the controller 101 initializes the directed subgraph G. For example, the controller 101 may initialize the directed subgraph G by initializing an influence score of each anomaly node and/or weights for each edge. For example, the controller 101 may initialize each anomaly node to a same initial influence score. For example, each anomaly node may be initialized with an initial influence score of 10. However, example embodiments are not limited this example and the anomaly nodes may be initialized to some other value. For example, some edges may have an associated weight. For example, an edge weight may have been determined by a previous ranking via the AARA. If an edge does not have an associated weight, a weight of the edge may be initialized to an initial weight of 1. Example embodiments should not, however, be limited to these examples and the edge weights may be initialized to some other value.

At S520, the controller 101 may perform a direct influence propagation on the directed subgraph G. For example, the controller 101 may update scores for each anomaly node based on direct neighboring anomaly nodes. For example, in a graph including nodes A, B, and C, each having an influence score initialized to 1, with node A connected to both node B and node C via edges b and c, respectively, each edge having a weight of 1, an influence score of node A would be 3 and an influence score of nodes B and C would be 2. For example, the influence score of node A may be equal to 1 (the initial value of node A) plus the influence (e.g., initial values) of the nodes connected to node A (1 from node B and 1 from node C); the influence score of node B may be equal to 1 (the initial value of node B) plus the influence (e.g., initial values) of the nodes connected to node B (e.g., 1 from node A); and the influence score of node C may be equal to 1 (the initial value of node C) plus the influence (e.g., initial values) of the nodes connected to node C (e.g., 1 from node A).

At S530, the controller 101 performs a topological sort on the directed subgraph G. A topological sort is a linear ordering of the anomaly nodes such that for every directed edge u→v anomaly node u comes before anomaly node v in the ordering.

At S540, the controller 101 detects and excludes loops in the directed subgraph G. For example, if correlations of the anomaly nodes in the directed subgraph G result in a loop in the directed subgraph G that is not acyclic, such a loop may be removed from the directed subgraph G. Detecting and excluding loops in the directed subgraph G maybe referred to as pruning the directed subgraph G.

At S550, the controller 101 propagates scores across the directed subgraph G. For example, the controller 101 may update influence scores of the anomaly nodes remaining in the directed subgraph G. For example, the influence score of an anomaly node may be updated based on the current influence score of the anomaly node and the influence scores of the neighboring anomaly nodes after the topological sort. For example, the current influence score of the anomaly node may be multiplied by the influence scores of the neighboring anomaly nodes. This result may be added to the current influence score of the anomaly node to determine the updated influence score of the anomaly node.

At S560, the controller ranks the anomalies based on influence scores of the anomaly nodes. For example, the anomaly nodes may be sorted according to their respective influence scores and ranked 1 to n according to their position in the ranked list, with 1 being assigned to the anomaly node with the highest influence score and n being assigned to the anomaly node with the lowest influence score, where n is the number of anomaly nodes remaining in the directed subgraph G. A rank assigned to an anomaly may be referred to as an anomaly score. The ranked list of anomalies may then be output as a list of attention ranked anomalies (ARA).

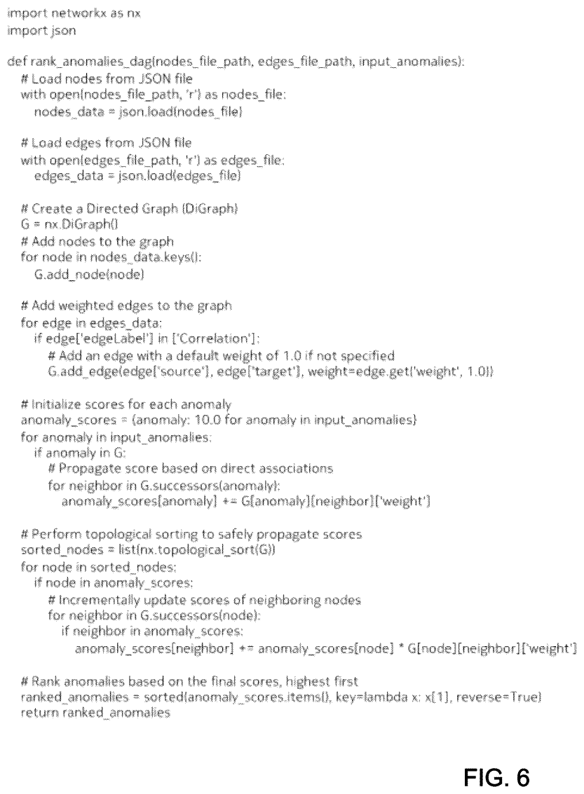

FIG. 6 is example pseudocode for an attention ranking algorithm according to example embodiments.

The AARA, according to example embodiments, calculates the anomaly scores by propagating influence scores through the graph, adding them up, and finally sorting the anomalies based on these calculated totals. This resulting ARA according to example embodiments reflects centrality of anomaly nodes in the graph, highlighting the most significant anomalies in terms of their correlation with other anomalies. The ranked list of anomalies and/or the anomaly scores therefore reflect the influence of the respective anomalies within the directed subgraph G. For example, the anomaly score and/or the influence score may indicate an amount of significance and/or correlation of occurrence of an anomaly on occurrences of other anomalies. For example, the anomaly score and/or the influence score may indicate a significance of the respective candidate anomaly in terms of a degree of correlation of the respective candidate anomaly with the other ones of the plurality of candidate anomalies. The anomaly scores may be similar/analogous to identifying the most connected people (e.g., people with a widest audience/influence/most social connections) in a social network.

The ARA according to example embodiments may serve at least three functions. First, the ARA may serve to provide key insights for scripts that generate CPTs, helping to reduce a large set of contributing anomalies to a manageable subset. Second, in conjunction with a root cause (RC) report generated by the RE (discussed in more detail later), the ARA may enable users (e.g., operations staff) to better understand which subset of anomalies influenced the joint conditional probability calculations made by the Bayesian network (BN), offering transparency that would otherwise be absent. Finally, the ARA may help users (e.g., network operations personnel) to focus on more significant alarms rather than an entire set of anomalies. For example, if there are 20 active anomalies (network alarms), the ARA algorithm can rank them by priority, enabling network operators to address the anomaly alarms that are most central among all the co-appearing anomalies first.

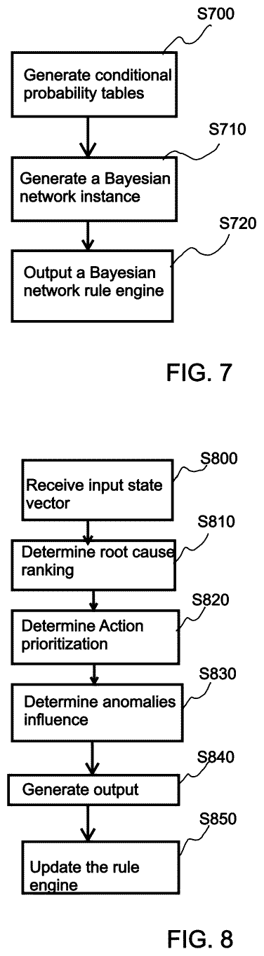

FIG. 7 is a flow chart illustrating a method for generating a rule engine, according to example embodiments. The method shown in FIG. 7 may be performed at the controller 101.

Referring to FIG. 7, at S700 the controller 101 generates conditional probability tables (CPTs). As discussed above, the controller 101 may generate the CPTs based on network diagnostic information (e.g., a DKM) that are prescribed by experts and encoded in DKG. According to example embodiments, a DKG reflecting the semantic ontology provided in DKM may be used to generate the CPTs.

Further, as discussed above, the AARA may be used to rank and/or filter anomaly nodes of the DKG used to generate the CPTs. For example, the AARA may filter and select the most significant anomalies from the DKG for generating the CPTs. For example, the AARA may rank a plurality of anomalies (e.g., candidate anomalies) based on a correlation with a plurality of other anomalies (e.g., other candidate anomalies). The AARA may generate a ranked list of the candidate anomalies. The CPTs may be generated based on a number of anomalies (e.g., 3 or 4) of the highest ranked candidate anomalies. Thus, according to example embodiments, the CPTs may be generated based on a set of most relevant anomalies. The CPTs may therefore be effective in identifying root causes caused by the most likely anomalies, while decreasing a size and/or complexity of the CPTs. Therefore, according to example embodiments, a BN may be generated based on a reduced amount and/or complexity of data while maintaining or improving a quality of a prediction of the BN.

At S710, the controller 101 generates a BN instance based on the CPTs and/or the DKG. For example, the BN may be generated based on a structure of the DKG and probability values declared within the CPTs. The BN may be generated based on the CPTs and/or the DKG according to any known method. For example, according to example embodiments, the BN instance may be generated based on CPTs that are based on (e.g., only on) the set of most relevant anomalies.

At S720, the controller 101 outputs the BNRE. For example, the BNRE may include the BN instance, the DKG, the CPTs, the AARA, and/or the ARA. The BNRE may be used, for example, by the controller 101, to determine potential root causes of network issues of network 10, to generate a list (e.g., a prioritized list) of recommended actions to refine anomaly detection and/or cure or mitigate a detected anomaly, to generate an ARA report, and/or to update the BNRE based on real time data of the network 10. According to some example embodiments, the BNRE may cause the system 1 to perform an action to refine anomaly detection and/or cure or mitigate a detected anomaly. For example, the BRNE may recommend and/or perform a recommended action of rebooting a device 11 that shows unusual memory consumption.

FIG. 8 is a flow chart illustrating a method of a rule engine, according to example embodiments. The method shown in FIG. 8 may be performed at the controller 101.

Referring to FIG. 8, at S800 the controller 101 receives an input state vector 901.

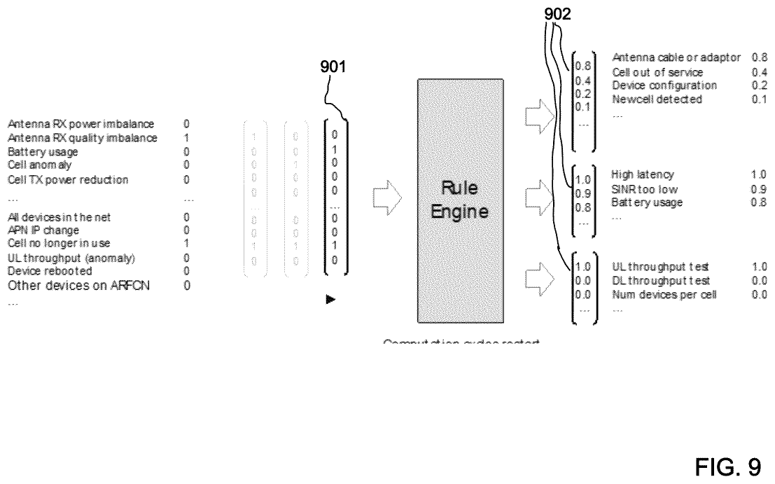

FIG. 9 is an illustration of example input and output vectors for a rule engine according to example embodiments.

The input state vector 901 may be generated by the anomaly detection device 110. For example, the plurality of devices 11 on the network 10 may report KPIs to the anomaly detection device 110. The anomaly detection device 110 may generate the state vector 901 based on the KPIs of the plurality of devices 11. For example, assume that there are 5 known anomalies (A1-A5) and 3 known conditions (C1-C3). The known conditions may indicate that the anomalies are being detected in devices 11 that are close together (rather than detected at one device 11, or by multiple devices 11 across the network 10). If the anomaly detection device 110 detects anomalies A2 and A3, and condition 2 is known to be occurring, then the input state vector may be 0, 1, 1, 0, 0, 0, 1, 0 (anomalies A2 and A3 are true, condition C2 is true).

The anomaly detection device 110 may periodically generate the input state vector 901. For example, the anomaly detection device 110 may generate the input state vector 901 once per second or once every three seconds. However, example embodiments are not limited to this example and the anomaly detection device 110 may generate the input state vector 901 more or less frequently. The input state vector 901 may include key performance indicators (KPI) anomaly state indicators, contextual state indicators, and/or action-result indicators. The KPI anomaly state indicators may indicate metrics related to performance anomalies of the network 10. For example, a KPI anomaly state indicator may indicate a reference signal received power (RSRP) is too low. The contextual state indicators may indicate environmental conditions of the network 10. For example, a contextual state indicator may indicate ongoing active maintenance tests on the network 10. The action-result indicators may indicate outcomes of previously triggered actions. For example, the BNRE may cause a client device to be rebooted and/or recommend a mitigation action of rebooting a client device. An action-result indicator may indicate the client device having been rebooted.

As shown in FIG. 9, the input vector 901 may include a plurality of anomaly flags, contextual flags, and/or action flags, each of which may be implemented as a binary flag. For example, the input vector 901 may include a binary flag indicating a presence or absence for each respective anomaly state, each respective contextual state, and/or each respective action-result.

Returning to FIG. 8, at S810 the controller 101 determines a root cause ranking based on the input vector 901 and the BN. For example, the BN may rank potential root causes of network 10 issues (e.g., anomalies) based on their probabilistic likelihood. For example, the root causes may correspond with the causations 202 of the DKG.

At S820, the controller 101 determines a prioritized list of recommended actions based on the input vector 901 and the BN. For example, the prioritized list of recommended actions may include specific tests or procedures to refine anomaly detection by triggering new metrics and/or improving the accuracy of future root cause analysis by the BNRE. For example, the recommended actions may correspond with the actions 205 of the DKM.

The actions may be processed in a deferred manner, allowing for iterative refinement over time. For example, assume that a device 11 reports a KPI indicating a “memory use too high” anomaly at time t1. A top action recommendation from the BNRE at the time t1 may indicate to take action A1 “reboot device”, and root cause “unknown”. The BNRE may trigger the action to reboot the device 11, which will take 4 units of time. For example, the BNRE may cause the system 1 to reboot the device and/or a user may reboot the device based on the output of the BNRE. At each subsequent time step (e.g., t2, t3, t4) the BNRE may indicate the action A1. Once the reboot action has completed at t5 a constraint C1 may indicate “device rebooted”. For example, the input vector 901 may indicate C1 as true. The BNRE may now show a root cause of “device SW problem,” while in the previous cycles (t1-t4) the root cause was “unknown”. Once C1 is shown as true, at t5 the BNRE may not continue to indicate the action A1.

At S830, the controller 101 determines updated anomaly influences for those anomalies that are active in the input vector 901 using the AARA. For example, the controller 101 may determine the updated anomaly influences according to the method described above with reference to FIG. 5. During runtime, the AARA may only rank anomalies present (indicated as active) in the input vector 901.

At S840, the controller 101 generates an output. For example, the BNRE may output at least one output vector 902. For example, the BNRE may output a vector 902 providing a ranked list of probable root causes, a vector 902 including suggested actions, such as specific tests, that can improve the root cause analysis, and/or a vector 902 including a ranking of the most significant anomalies. However, example embodiments are not limited to this example, and the above discussed vectors 902 may be output as a single vector 902.

According to some example embodiments, the controller 101 may provide an output to a user. For example, the controller 101 may provide an output via a graphical user interface on a display. The output may be based on the output vectors 902. For example, according to some example embodiments, the controller 101 may display, on the display, at least one of a root cause analysis, mitigation actions, and/or an ARA report.

The root cause analysis may include a probabilistically quantified and ranked list of root causes based on the output vector 902. For example, the root causes included in the root cause analysis may correspond with the causations 202 included in the DKM. The root cause analysis may provide network operators with actionable insights for prioritizing troubleshooting activities for the network 10.

The diagnostic and/or mitigation actions may include a probabilistically quantified list of recommended diagnostic and/or mitigation actions based on the output vector 902. For example, according to example embodiments the diagnostic actions may provide more information to better determine root causes. An example of a diagnostic action may be a throughput test (e.g., an intrusive bandwidth test) to determine current data carrying capacity of the network 10, and/or to adjust an antenna, etc. An example of a mitigation action may be to replace a device and/or upgrade/update software on a device, etc. For example, the mitigation actions may correspond with the actions 205 included in the DKM.

According to some example embodiments, the controller 101 may automatically cause the network 10 to perform at least one diagnostic and/or mitigation action included in the list of diagnostic and/or mitigation actions. For example, the controller 101 may cause the network to perform the highest ranked diagnostic and/or mitigation action. However, example embodiments are not limited to this example. For example, the controller 101 may cause the network to perform more or fewer of the diagnostic and/or mitigation actions. For example, the controller 101 may cause the network 10 to perform a highest ranked diagnostic and/or mitigation action that is automatically performable.

As the diagnostic and/or mitigation actions are executed, new data is collected by the network 10 and provided to the BNRE in a next input vector 901. This may enable the BNRE to incorporate updated information in the next computation cycle. This iterative feedback loop may continuously improve the accuracy of anomaly detection and root cause analysis of the BNRE according to example embodiments.

The ARA report may include a ranked list of the anomalies. For example, the ranked list of anomalies may be ranked based on the anomaly scores and/or the influence scores determined by the AARA.

Because the root cause analysis from the BN may appear opaque to network operators, the ARA report may serve to provide further clarity. For example, the ARA report may accompany the root cause analysis and help operators to understand which anomalies contributed to the computation of root causes. The ARA report may include only the anomalies ranked at runtime (e.g., only the anomalies indicated as active in the input vector 901). The ARA report may indicate an anomaly cutoff used during CPT generation. For example, the ARA report may indicate the top ranked anomalies and how many of the top ranked anomalies were used during the CPT generation.

In addition to providing further clarity with regards to the root cause analysis, the ARA report may serve as an alarm prioritization tool for the network operator. For example, if there are 20 active anomalies (network alarms), the ARA report may rank them by priority, enabling network operators to address the anomaly alarms that are most central among all the co-appearing anomalies first.

Still referring to FIG. 8, at S850 the controller 101 periodically updates the BNRE. For example, the controller 101 may update the BNRE based on the ARA generated by the AARA. For example, the DKM and/or DKG may be updated periodically. For example, experts may update the DKM and/or the DKG based on newer/more up to date expert knowledge. Alternatively, according to some example embodiments, the controller 101 may update the DKG automatically. For example, the controller may update the DKG according to a machine learning (ML) algorithm such as a deep neural network (DNN).

When the DKG is updated (e.g., based on an updated DKM and/or via a ML algorithm) the BNRE may be regenerated. For example, the controller 101 may regenerate the BNRE as discussed above with reference to FIGS. 5-7. Therefore, according to example embodiments, a BNRE may reflect the most influential anomalies present in the network 10 in real time.

Although the terms first, second, etc. may be used herein to describe various elements, these elements should not be limited by these terms. These terms are only used to distinguish one element from another. For example, a first element could be termed a second element, and similarly, a second element could be termed a first element, without departing from the scope of this disclosure. As used herein, the term “and/or,” includes any and all combinations of one or more of the associated listed items.

When an element is referred to as being “connected,” or “coupled,” to another element, it can be directly connected or coupled to the other element or intervening elements may be present. By contrast, when an element is referred to as being “directly connected,” or “directly coupled,” to another element, there are no intervening elements present. Other words used to describe the relationship between elements should be interpreted in a like fashion (e.g., “between,” versus “directly between,” “adjacent,” versus “directly adjacent,” etc.).

The terminology used herein is for the purpose of describing particular embodiments only and is not intended to be limiting. As used herein, the singular forms “a,” “an,” and “the,” are intended to include the plural forms as well, unless the context clearly indicates otherwise. It will be further understood that the terms “comprises,” “comprising.” “includes,” and/or “including,” when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Specific details are provided in the following description to provide a thorough understanding of example embodiments. However, it will be understood by one of ordinary skill in the art that example embodiments may be practiced without these specific details. For example, systems may be shown in block diagrams so as not to obscure the example embodiments in unnecessary detail. In other instances, well-known processes, structures and techniques may be shown without unnecessary detail in order to avoid obscuring example embodiments.

As discussed herein, illustrative embodiments will be described with reference to acts and symbolic representations of operations (e.g., in the form of flow charts, flow diagrams, data flow diagrams, structure diagrams, block diagrams, etc.) that may be implemented as program modules or functional processes include routines, programs, objects, components, data structures, etc., that perform particular tasks or implement particular abstract data types and may be implemented using existing hardware at, for example, existing network apparatuses, elements or entities including cloud-based data centers, computers, cloud-based servers, or the like. Such existing hardware may be processing or control circuitry such as, but not limited to, one or more processors, one or more Central Processing Units (CPUs), one or more controllers, one or more arithmetic logic units (ALUs), one or more digital signal processors (DSPs), one or more microcomputers, one or more field programmable gate arrays (FPGAs), one or more System-on-Chips (SoCs), one or more programmable logic units (PLUS), one or more microprocessors, one or more Application Specific Integrated Circuits (ASICs), or any other device or devices capable of responding to and executing instructions in a defined manner.

Although a flow chart may describe the operations as a sequential process, many of the operations may be performed in parallel, concurrently or simultaneously. In addition, the order of the operations may be re-arranged. A process may be terminated when its operations are completed, but may also have additional steps not included in the figure. A process may correspond to a method, function, procedure, subroutine, subprogram, etc. When a process corresponds to a function, its termination may correspond to a return of the function to the calling function or the main function.

As disclosed herein, the term “storage medium.” “computer readable storage medium” or “non-transitory computer readable storage medium” may represent one or more devices for storing data, including read only memory (ROM), random access memory (RAM), magnetic RAM, core memory, magnetic disk storage mediums, optical storage mediums, flash memory devices and/or other tangible machine-readable mediums for storing information. The term “computer-readable medium” may include, but is not limited to, portable or fixed storage devices, optical storage devices, and various other mediums capable of storing, containing or carrying instruction(s) and/or data.

Furthermore, example embodiments may be implemented by hardware, software, firmware, middleware, microcode, hardware description languages, or any combination thereof. When implemented in software, firmware, middleware or microcode, the program code or code segments to perform the necessary tasks may be stored in a machine or computer readable medium such as a computer readable storage medium. When implemented in software, a processor or processors will perform the necessary tasks. For example, as mentioned above, according to one or more example embodiments, at least one memory may include or store computer program code, and the at least one memory and the computer program code may be configured to, with at least one processor, cause a network apparatus, network element or network device to perform the necessary tasks. Additionally, the processor, memory and example algorithms, encoded as computer program code, serve as means for providing or causing performance of operations discussed herein.

A code segment of computer program code may represent a procedure, function, subprogram, program, routine, subroutine, module, software package, class, or any combination of instructions, data structures or program statements. A code segment may be coupled to another code segment or a hardware circuit by passing and/or receiving information, data, arguments, parameters or memory contents. Information, arguments, parameters, data, etc. may be passed, forwarded, or transmitted via any suitable technique including memory sharing, message passing, token passing, network transmission, etc.

The terms “including” and/or “having,” as used herein, are defined as comprising (i.e., open language). The term “coupled,” as used herein, is defined as connected, although not necessarily directly, and not necessarily mechanically. Terminology derived from the word “indicating” (e.g., “indicates” and “indication”) is intended to encompass all the various techniques available for communicating or referencing the object/information being indicated. Some, but not all, examples of techniques available for communicating or referencing the object/information being indicated include the conveyance of the object/information being indicated, the conveyance of an identifier of the object/information being indicated, the conveyance of information used to generate the object/information being indicated, the conveyance of some part or portion of the object/information being indicated, the conveyance of some derivation of the object/information being indicated, and the conveyance of some symbol representing the object/information being indicated.

According to example embodiments, network apparatuses, elements or entities including cloud-based data centers, computers, cloud-based servers, or the like, may be (or include) hardware, firmware, hardware executing software or any combination thereof. Such hardware may include processing or control circuitry such as, but not limited to, one or more processors, one or more CPUs, one or more controllers, one or more ALUs, one or more DSPs, one or more microcomputers, one or more FPGAs, one or more SoCs, one or more PLUS, one or more microprocessors, one or more ASICs, or any other device or devices capable of responding to and executing instructions in a defined manner.

What is claimed is:

1. A method for determining at least one root cause of at least one detected anomaly in a communication network, the method comprising:
determining an influence score for each respective candidate anomaly of a plurality of candidate anomalies based on a correlation with other ones of the plurality of candidate anomalies;
ranking the plurality of candidate anomalies based on the respective influence scores;
updating, based on the ranked plurality of candidate anomalies, a rule engine by simplifying at least one of a Bayesian network or a conditional probability table; wherein the simplifying includes regenerating at least one of the Bayesian network or the conditional probability table based on the ranked plurality of candidate anomalies and a diagnostic knowledge graph, the diagnostic knowledge graph specifying a probabilistically quantified relation between the at least one root cause and the candidate anomalies, wherein the simplifying includes reducing a complexity of the conditional probability table by including only a subset of the candidate anomalies having a highest influence score in the regenerating the conditional probability table,
determining at least one root cause of the at least one detected anomaly based on the rule engine and the at least one detected anomaly; and
displaying the at least one root cause.

2. The method of claim 1, further comprising:
generating at least one of the Bayesian network or the conditional probability table based on the diagnostic knowledge graph, the diagnostic knowledge graph including at least one anomaly node, at least one constraint node, at least one action node, and at least one root cause node,
wherein edges of the diagnostic knowledge graph indicate anomaly to root cause relations and correlations between anomalies.

3. The method of claim 2, wherein the anomaly to root cause relations are probabilistically quantified.

4. The method of claim 2, wherein the edges further indicate anomaly to action relations.

5. The method of claim 1, further comprising:
displaying at least one recommended action based on the at least one root cause.

6. The method of claim 5, wherein the determining the influence score for each respective candidate anomaly includes determining the influence score for each respective candidate anomaly of the plurality of candidate anomalies based on the at least one recommended action.

7. The method of claim 1, wherein the determining the influence score for each respective candidate anomaly includes determining the influence score for each respective candidate anomaly of the plurality of candidate anomalies based on environmental conditions of the communication network.

8. The method of claim 1, wherein the influence score indicates a significance of the respective candidate anomaly in terms of a degree of correlation of the respective candidate anomaly with the other ones of the plurality of candidate anomalies.

9. The method of claim 1, further comprising:
automatically performing at least one action to improve the determining the at least one root cause, the at least one action based on the at least one root cause.

10. A device comprising:
at least one memory storing computer program code; and
at least one processor configured to execute the computer program code and cause the device to
determine an anomaly influence score for each respective candidate anomaly of a plurality of candidate anomalies based on a correlation with other ones of the plurality of candidate anomalies,
rank the plurality of candidate anomalies based on the respective influence scores,
update, based on the ranked plurality of candidate anomalies, a rule engine by simplifying at least one of a Bayesian network or a conditional probability table, wherein the simplifying includes regenerating at least one of the Bayesian network or the conditional probability table based on the ranked plurality of candidate anomalies and a diagnostic knowledge graph, the diagnostic knowledge graph specifying a probabilistically quantified relation between the at least one root cause and the candidate anomalies, wherein the simplifying includes reducing a complexity of the conditional probability table by including only a subset of the candidate anomalies having a highest influence score in the regenerating the conditional probability table,
determine at least one root cause of the at least one detected anomaly in a communication network based on the rule engine and the at least one detected anomaly, and
display the at least one root cause.

11. The device of claim 10, wherein the at least one memory and the computer program code are further configured to, with the at least one processor, cause the device to generate at least one of the Bayesian network or the conditional probability table based on the diagnostic knowledge graph, the diagnostic knowledge graph including at least one anomaly node, at least one constraint node, at least one action node, and at least one root cause node,
wherein edges of the diagnostic knowledge graph indicate anomaly to root cause relations and correlations between anomalies.

12. The device of claim 11, wherein the anomaly to root cause relations are probabilistically quantified.

13. The device of claim 11, wherein the edges further indicate anomaly to action relations.

14. The device of claim 10, wherein the at least one memory and the computer program code are further configured to, with the at least one processor, cause the device to display at least one recommended action based on the at least one root cause.

15. The device of claim 14, wherein the at least one memory and the computer program code are further configured to, with the at least one processor, cause the device to determine the influence score for each respective candidate anomaly based on the at least one recommended action.

16. The device of claim 10, wherein the at least one memory and the computer program code are further configured to, with the at least one processor, cause the device to determine the influence score for each respective candidate anomaly of the plurality of candidate anomalies based on environmental conditions.

17. The device of claim 10, wherein the influence score indicates a significance of the respective candidate anomaly in terms of a degree of correlation of the respective candidate anomaly with the other ones of the plurality of candidate anomalies.

18. The device of claim 10, wherein the at least one memory and the computer program code are further configured to, with the at least one processor, cause the device to automatically perform at least one action to improve the determining the at least one root cause, the at least one action based on the at least one root cause.
